(19) United States
(12) Patent Application Publication
(10) Pub. No.: US 2015/0009185 A1
(43) Pub. Date: Jan. 8, 2015

(54) TOUCH SYSTEMS AND METHODS EMPLOYING ACOUSTIC SENSING IN A THIN COVER GLASS

(71) Applicant: CORNING INCORPORATED, CORNING, NY (US)

(72) Inventors: Zhiqiang Shi, Shrewsbury, MA (US); Ningli Yang, Rocky Hill, CT (US)

(21) Appl. No.: 14/322,227

(22) Filed: Jul. 2, 2014

Related U.S. Application Data
(60) Provisional application No. 61/843,612, filed on Jul. 8, 2013.

(51) Int. Cl. G06F 3/043

(52) U.S. Cl. CPC G06F 3/0436
USPC 345/177

(57) ABSTRACT

Touch systems and methods that employ acoustic sensing in a thin glass sheet are disclosed. The touch system includes a generally planar acoustic-sensing assembly that includes the thin glass sheet. Thin-film piezoelectric acoustic transducers are arranged on the top surface or the bottom surface and adjacent the perimeter and serve as either transmitters or receivers. A signal-processing algorithm run on a controller is used to process the receiver signals to determine at least one characteristic of a touch event. Use of a thin glass sheet allows for the acoustic transducers to operate at a frequency f in the range from 0.5 MHz to 5 MHz, thereby providing for excellent pressure sensitivity and spatial resolution of touch events.

### CROSS REFERENCES TO RELATED APPLICATIONS

This application claims the benefit of priority under 35 U.S.C. §119 to U.S. Provisional Application Ser. No. 61/843,612, filed on Jul. 8, 2013, the content of which is relied upon and incorporated herein by reference in its entirety.

### FIELD

The present disclosure relates to touch-sensitive devices, and in particular to touch systems and methods that employ acoustic sensing in a thin cover glass.

### BACKGROUND ART

The market for displays and other devices (e.g., keyboards) having non-mechanical touch functionality is rapidly growing. As a result, touch-sensing techniques have been developed to enable displays and other devices to have touch functionality. Touch-sensing functionality is gaining wider use in mobile device applications, such as smart phones, e-book readers, laptop computers and tablet computers.

Touch systems in the form of touch screens have been developed that respond to a variety of types of touches, such as single touches, multiple touches, swiping, and touches. The main touch-sensing techniques are electrical (i.e., capacitance-based), optical and acoustic. While these main touch-sensing techniques are effective, there remains a need for improved approaches to touch-sensing that can provide the required sensitivity to sense touch events while also being able to accurately determine the location of and pressure at each touch event.

### SUMMARY

Additional features and advantages of the disclosure are set forth in the detailed description that follows, and in part will be readily apparent to those skilled in the art from that description or recognized by practicing the disclosure as described herein, including the detailed description that follows, the claims, and the appended drawings.

The claims as well as the Abstract are incorporated into and constitute part of the Detailed Description set forth below.

All publications, articles, patents, published patent applications and the like cited herein are incorporated by reference herein in their entirety.

### BRIEF DESCRIPTION OF THE DRAWINGS

FIG. 1 is schematic diagram of an example touch system according to the disclosure that includes an acoustic-sensing assembly having acoustic transducers arranged on the top or bottom surfaces of a thin glass sheet;

FIGS. 2A and 2B are cross-sectional views of examples of the acoustic-sensing assembly of FIG. 1;

FIG. 2C is similar to FIG. 2A and shows a finger causing a touch event at a touch location, and also shows the downward force caused by the touch event that generates a pressure at the touch event;

FIGS. 3A and 3B are schematic diagrams of the time-evolution of an example acoustic-wave pulse illustrating the attenuation and dispersion of the acoustic wave when there is no touch event (FIG. 3A) and when there is an touch event (FIG. 3B);

FIG. 4A is an elevated exploded view and FIG. 4B is a cross-sectional view taken in the X-Z plane of an example touch screen system, wherein the acoustic-sensing assembly is interfaced with the light-emitting side of a display panel;

FIG. 4C is the same as FIG. 4B, but showing an example where pressure applied by a stylus implement at a touch location gives rise to a touch event that causes the glass sheet to locally bend and touch an acoustic-absorbing film on a display panel;

FIG. 5A is a schematic diagram of an example inter-digital acoustic transducer (IDT) transmitter showing an example diverging acoustic wave emanating therefrom at a divergence angle φ;

FIG. 5B plots the normalized amplitude A of an example acoustic wave versus the divergence angle φ in degrees;

FIG. 6 is a close-up view of a portion of an acoustic-sensing assembly showing an example of how the glass sheet can be divided up into pixels;

FIG. 7 is a top-down view of an example acoustic-sensing assembly that shows select transmitters and receivers used in performing simulations to detect a touch event;

FIG. 8A plots the normalized signal values associated with transmitters TY and receivers RY from Table 1A for the no-touch baseline;

FIG. 8B plots the normalized signal values associate with transmitters TY and receivers RY values from Table 2A for the touch event TE at touch location TL(5,5);

FIG. 8C plots the TY and RY values of Table 2A with the baseline values of Table 1A subtracted out and then the absolute value of the data taken;

FIG. 8D is similar to FIG. 8C, except that the plot is for the TX and RX values of Table 2B;

FIG. 8E is similar to FIG. 8C and but for two touch events; and

FIG. 9 plots the pressure P_{TE} (arbitrary units) vs. time illustrating how a best-fit curve to the pressure data can be used to better characterize the time-evolution of the pressure applied at a touch location.

Cartesian coordinates are shown in certain of the Figures for the sake of reference and are not intended as limiting with respect to direction or orientation.

### DETAILED DESCRIPTION

The present disclosure can be understood more readily by reference to the following detailed description, drawings, examples, and claims, and their previous and following description. However, before the present compositions, articles, devices, and methods are disclosed and described, it is to be understood that this disclosure is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the disclosure is provided as an enabling teaching of the disclosure in its currently known embodiments. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

### Touch System

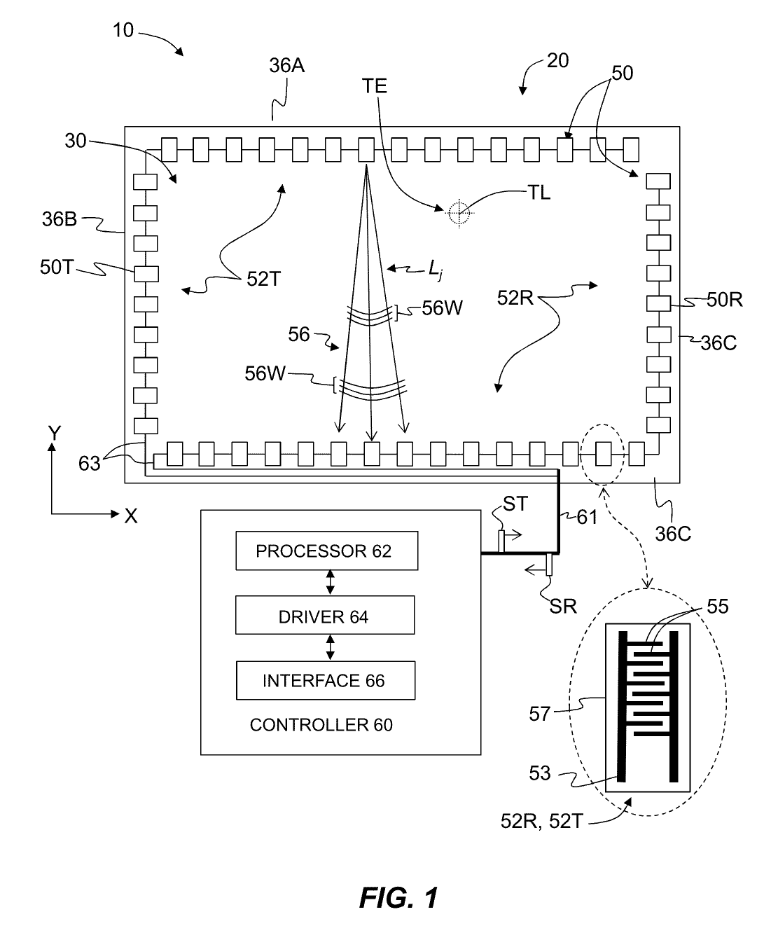

FIG. 1 is a schematic diagram of an example touch system 10 according to the disclosure. The touch system 10 may be used in a variety of consumer electronic articles, for example, in conjunction with displays for cell phones, smart phones, keyboards, smart pads, touch screens, lap tops, and other electronic devices such as those capable of wireless communication, music players, notebook computers, mobile devices, game controllers, computer “mice,” electronic book readers, and the like.

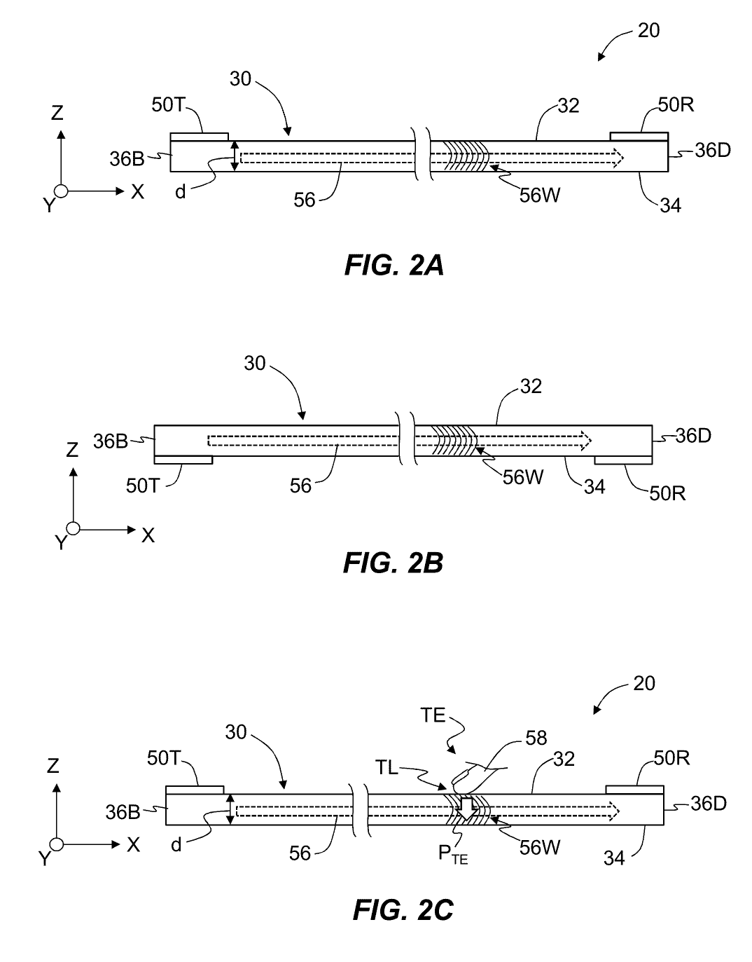

The example touch system 10 of FIG. 1 includes a generally planar acoustic-sensing assembly (“assembly”) 20. Assembly 20 includes a thin sheet of glass 30, shown in cross-section in FIGS. 2A and 2B. Glass sheet 30 has a body 31 with substantially parallel top and bottom planar surfaces 32 and 34 and sides 36A, 36B, 36C and 36D. The substantially parallel top and bottom planar surfaces 32 and 34 define a substantially constant thickness d. In an example, thickness d is in the range defined by 0.1 mm≦d≦1 mm. Thin glass sheet 30 serves as a cover glass for assembly 20.

In an example, glass sheet 30 is a chemically strengthened glass, such as Gorilla Glass®, made by Corning, Inc. of Corning, N.Y.

Assembly 20 includes a plurality of acoustic transducers 50. A first sub-set of acoustic transducers 50 are used as transmitters and are referred to as transmitters 50T, with the first subset defining a transmitter array 52T. A second sub-set is used as receivers and are referred to as receivers 50R, with the second subset defining a receiver array 52R. In an example, transmitters 50T are arranged adjacent sides 36A and 36B, while receivers 50R are arranged adjacent sides 36C and 36D. Glass sheet 30 is shown by way of example as being rectangular with four distinct sides, but other shapes (e.g., other polygonal shapes, circular, etc.) can be employed. Transmitters 50T and receivers 50R are generally arranged in pairs, with the receiver being directly across from the paired transmitter.

In an example, transmitters 50T and receivers 50R are arranged on either top surface 32 (FIG. 2A) or bottom surface 34 (FIG. 2B) of glass sheet 30. Each transmitter 50T is adapted to generate an acoustic wave 56 having an acoustic frequency f, as described in greater detail below. FIG. 1 shows acoustic wave 56 with associated acoustic wavefronts 56W. In an example, acoustic wave 56 is sent out in a pulse or a series of pulses, in which case wavefronts 56W represent a single acoustic-wave pulse. In an example, acoustic-wave pulses 56W are emitted by transmitter 50T at a frequency γ sufficient to sample the occurrence of touch events TE. In an example embodiment, frequency γ is in the range from 1 Hz≦γ≦100 Hz.

In an example, the acoustic wave 56 from a given transmitter 56 is received by between one and 100 receivers 50R, which includes the paired receiver. The number of receivers 50R that receive a given acoustic wave 56 depends on the distance separating the transmitters and receivers, the spacing between the receivers, and the directionality (i.e., divergence angle) of the acoustic wave.

In an example, acoustic transducers 50 are thin-film based and are formed directly on top surface 32 or bottom surface 34 of glass sheet 30. In an example, acoustic transducers 50 are IDT piezoelectric thin-film acoustic transducers each having an electrode 53 and interleaved digits 55, as shown in the close-up inset of FIG. 1. Electrode 53 is interfaced with a piezoelectric film 57. The IDT piezoelectric thin-film acoustic transducers 50 are configured to excite a select acoustic frequency f as defined by the spacing between the interleaved digits 55 in response to receiving a transmit signal, as described below.

In an example, the IDT piezoelectric thin-film acoustic transducers 50 can be fabricated using first a thin-film process technique to deposit piezoelectric film 57, such as PVDF, on the top or bottom surfaces 32 or 34 of glass sheet 30. Either a wet process, such as a coating method, or a dry process, such as lamination of a thin piezoelectric film on the glass, can be employed. A printing technology, such as screen printing with the desired IDT pattern, can then be used to fabricate the IDT electrode 53 atop piezoelectric film 57.

Alternatively, the above two process can be reversed, i.e., printing the IDT electrode 53 first, then coating or laminating the piezoelectric film 57 atop the IDT electrode. Compared to conventional single-chip piezoelectric transducers, IDT-based acoustic transducers 50 have better frequency and acoustic mode selection, i.e., more accurate dispersion analysis for spatial resolution and pressure sensitivity. Example methods of forming IDT transducers 50 based on laminate piezoelectric films such as PVDF or copolymer P(VDF_{0.75}−TrFE_{0.25}) are describe in the article by Brown, L. F., “Design considerations for piezoelectric polymer ultrasound transducers,” IEEE Transactions on Ultrasonics, Ferroelectrics and Frequency Control, Vol. 47, Issue 6, November 2000, pp. 1377-1396.

Fabricating acoustic transducers 50 directly on the top or bottom surfaces 32 or 34 of glass sheet 30 eliminates sources of reflection, such as notches as used in conventional surface-acoustic wave (SAW) touch panels. Such notches can also weaken glass sheet 30 given that the glass sheet is relatively thin. It also simplifies the configuration of assembly 20 by obviating the need for reflection gratings and other ancillary structures used in the prior art to generate and direct acoustic waves.

In an example embodiment, acoustic transducers 50 are configured to generate acoustic waves 56 of frequency f in the low-dispersion A₀ mode, wherein frequency f is in the range from 0.5 MHz to 5 MHz. This frequency range falls between the standard SAW frequency of nominally 5 MHz and the dispersive signal technology (DST) and acoustic pulse recognition (APR) frequencies that generally fall in the range from 20 kHz to 60 kHz. Operating in the frequency range for frequency f provides comparable pressure sensitivity and spatial resolution to SAW-based touch screens while also providing greater touch sensitivity and spatial resolution as compared to DST-based or APR-based touch systems.

The optimum frequency f within the stated frequency range depends on the thickness d of glass sheet 30.

In example embodiments of the disclosure such as illustrated in FIG. 2C, an implement 58, such as a finger, applies a downward force on the top surface 32 of glass sheet 30 at touch location TL associated with a touch event TE. The downward force defines a pressure P_{TE} (force per area) at the touch location TL. The implement 58 interacts with and attenuates those acoustic waves 56W transmitted by transmitters 50T and received by receivers 56R that transect the touch location. Aspects of the disclosure include determining at least one characteristic of at least one touch event TE, such as: a touch-event occurrence, a touch-event location TL(x,y), a touch-event duration TE(t), a touch-event pressure P_{TE}, and a touch-event time-evolution of the touch-event pressure P_{TE}(t).

With continuing reference to FIG. 1, touch system 10 includes a controller 60 that is operably connected (e.g., via a bus 61 and wires 63) to the one or more transmitters 50T and the one or more receivers 50R. In an example, wires 63 comprise conducting films formed direction on the corresponding top or bottom glass surface on which transducers 50 are formed. In an example, Controller 60 is configured to control the operation of touch system 10 to ascertain at least one characteristic of at least one touch event TE. In some embodiments, the controller 300 includes a processor 62, a device driver 64 and interface circuitry 66, all operably arranged. Controller 60 controls transmitters 50T via transmit signal ST and also receives and processes receiver signals SR from receivers 50R.

In an example, controller 60 comprises a computer and includes a device, for example, a floppy disk drive, CD-ROM drive, DVD drive, magnetic optical disk (MOD) device (not shown), or any other digital device including a network connecting device such as an Ethernet device (not shown) for reading instructions and/or data from a computer-readable medium, such as a floppy disk, a CD-ROM, a DVD, a MOD or another digital source such as a network or the Internet, as well as yet to be developed digital means. The computer executes instructions embodied in a computer-readable medium (e.g., stored in firmware and/or software) to cause the controller to perform signal processing to determine at least one characteristic of at least one touch event TE.

The computer is programmable to perform functions described herein, including the operation of touch system 10 and any signal processing that is required to determine at least one characteristic of at least one touch event TE. As used herein, the term computer is not limited to just those integrated circuits referred to in the art as computers, but broadly refers to computers, processors, microcontrollers, microcomputers, programmable logic controllers, application-specific integrated circuits, FPGAs, and other programmable circuits, and these terms are used interchangeably herein.

Software may implement or aid in performing the touch location and pressure-sensing functions and operations disclosed herein, including in the execution of one or more algorithms for processing receiver signals SR to determine at least one characteristic of at least one touch event TE. The software may be operably installed in controller 60 or processor 62. Software functionalities may involve programming, including executable code, and such functionalities may be used to implement the methods disclosed herein. Such software code is executable by the general-purpose computer or by one or more processors, e.g., processor 62.

In operation, the software code and possibly the associated data records are stored within a general-purpose computer platform, within the processor unit, or in local memory. At other times, however, the software may be stored at other locations and/or transported for loading into the appropriate general-purpose computer systems. Hence, the embodiments discussed herein involve one or more software products in the form of one or more modules of code carried by at least one machine-readable medium. Execution of such code by a processor of the computer system or by the processor unit enables the platform to implement the catalog and/or software downloading functions, in essentially the manner performed in the embodiments discussed and illustrated herein.

The computer and/or processor 62 may each employ a computer-readable medium or machine-readable medium, which refers to any medium that participates in providing instructions to a processor for execution, including for example, determining at least one characteristic associated with a touch event TE, as explained below. Any memory discussed below constitutes a computer-readable medium. Such a medium may take many forms, including but not limited to, non-volatile media, volatile media, and transmission media. Non-volatile media include, for example, optical or magnetic disks, such as any of the storage devices in any computer(s) operating as one of the server platforms, discussed above. Volatile media include dynamic memory, such as main memory of such a computer platform. Physical transmission media include coaxial cables; copper wire and fiber optics, including the wires that comprise a bus within a computer system. In an example, processor 62 comprises an FPGA programmed with hardware description language (HDL) or comprises one or more application-specific logic integrated circuits (ASICs).

Common forms of computer-readable media therefore include, for example: a floppy disk, a flexible disk, hard disk, magnetic tape, any other magnetic medium, a CD-ROM, DVD, any other optical medium, less commonly used media such as punch cards, paper tape, any other physical medium with patterns of holes, a RAM, a PROM, and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

In an example, controller 60 also employs a high-speed pulse generator, such as an ultrasound transmit pulser (e.g. the LM96550 from Texas instruments, Inc. Austin, Tex.) to provide transmit signals ST that cause transmitters 50T to generate acoustic waves 56. Also in an example embodiment, controller 60 includes a multi-channel ultrasound amplifier/ADC device, such as the 8-channel I/Q demodulator model AD9279 from Analog Devices, to control the operation of receivers 50R. The model AD9279 includes a variable gain amplifier (VGA) with a low noise preamplifier (LNA), an antialiasing filter (AAF), an analog-to-digital converter (ADC), and an I/Q demodulator with programmable phase rotation.

Controller 60 is thus adapted to trigger transmitters 50T to generate acoustic waves 56 and acquire the corresponding receiver signals from receivers 50R. The acquired receiver signals SR are processed by controller 60 using a reconstruction algorithm to determine at least one characteristic of each touch event TE. This sequence is continuously repeated at frequency γ for real time monitoring of the touch events TE.

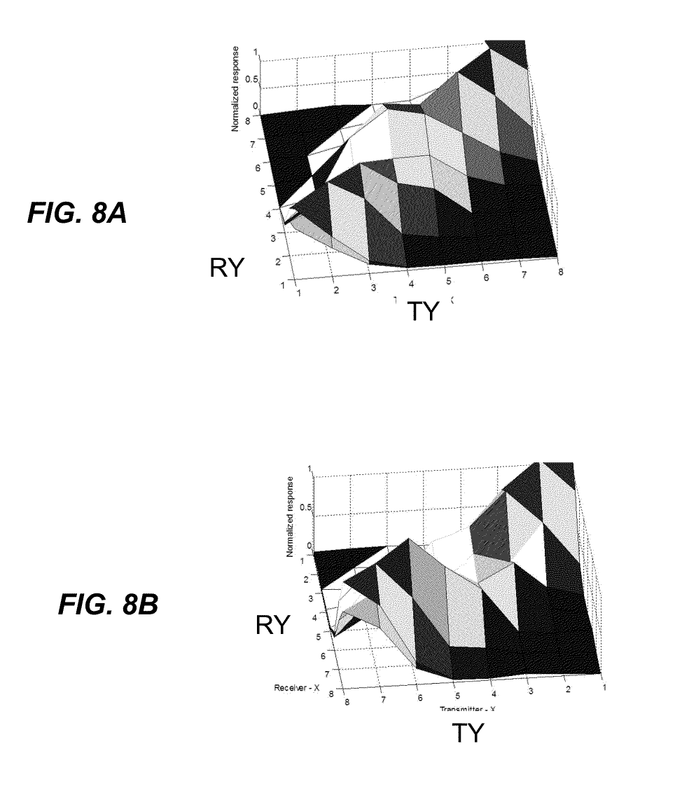

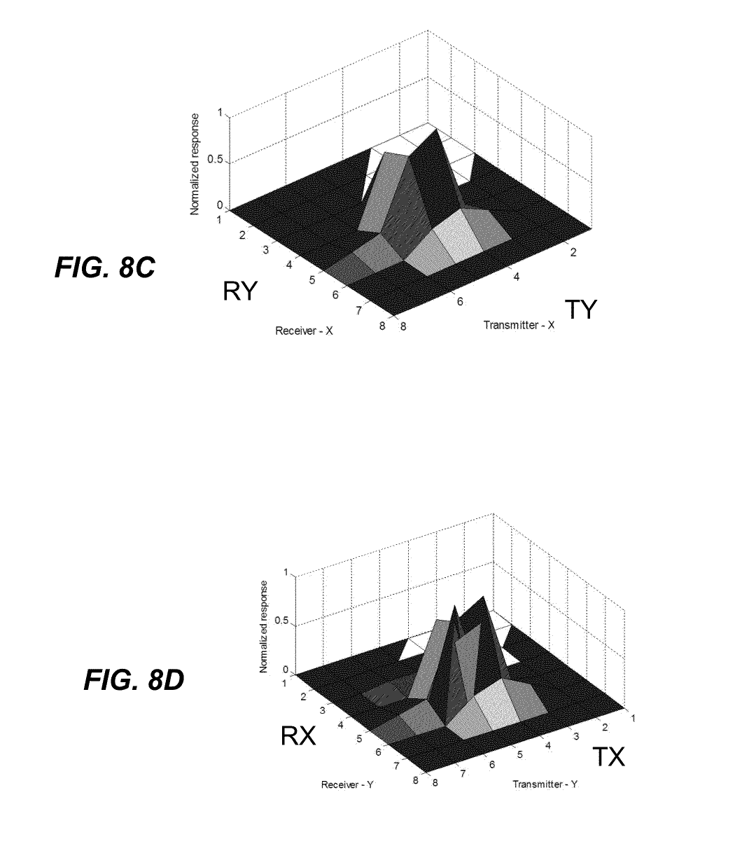

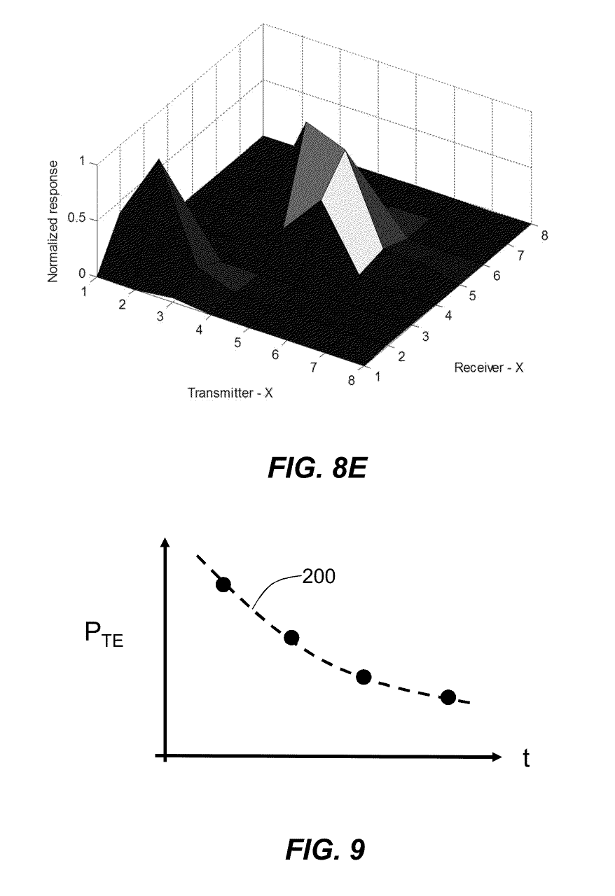

Controller 60 is also configured to receive and process the receiver signals SR to create a “map” of glass sheet 30, including a baseline map of unperturbed acoustic signals 56 through the glass, as well as a map of deviations and a threshold that is used to indicate the occurrence of one or more touch events TE. Tables 1A, 2A, 1B and 2B set forth below and FIGS. 8A through 8E discussed below illustrate examples of such maps.

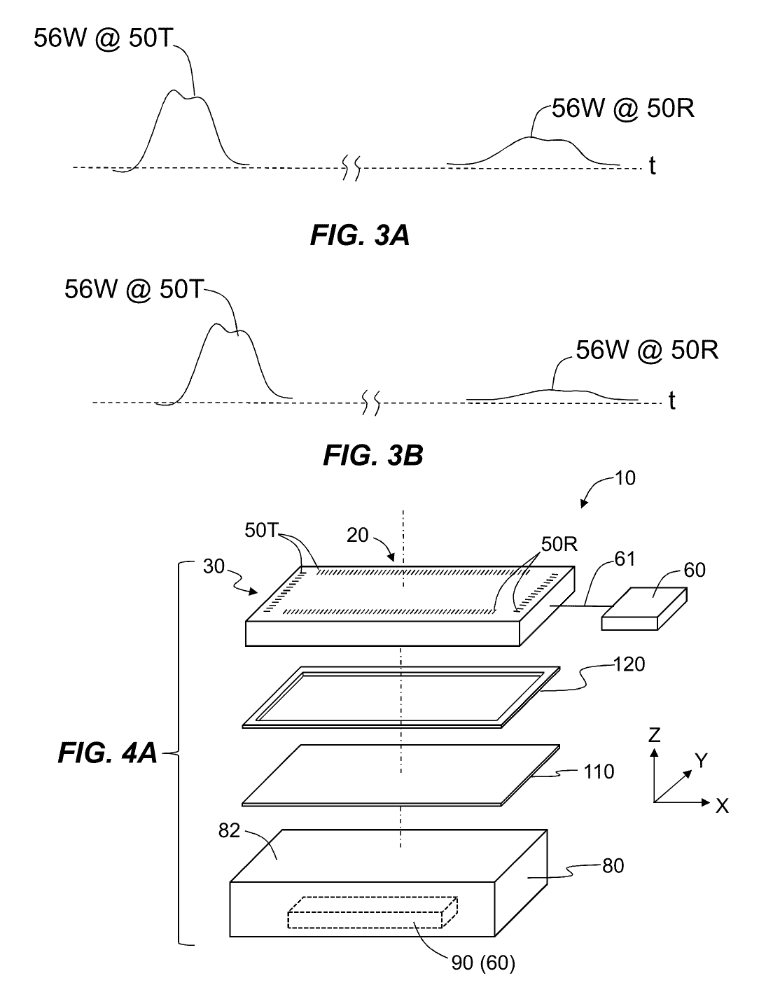

FIG. 3A is a schematic diagram of the time-evolution of acoustic-wave pulse 56W that starts out at transmitter 50T and arrives at its paired receiver 50R without a touch event affecting the transmission. There is some attenuation and dispersion of the acoustic-wave pulse 56W due to traveling through body 31 of glass sheet 30.

FIG. 3B is a similar diagram illustrating the time-evolution of acoustic-wave pulse 56W when the pulse is affected by a touch event TE. The acoustic-wave pulse 56 experiences greater attenuation and may also experience more dispersion.

Assembly Interfaced with a Display Panel

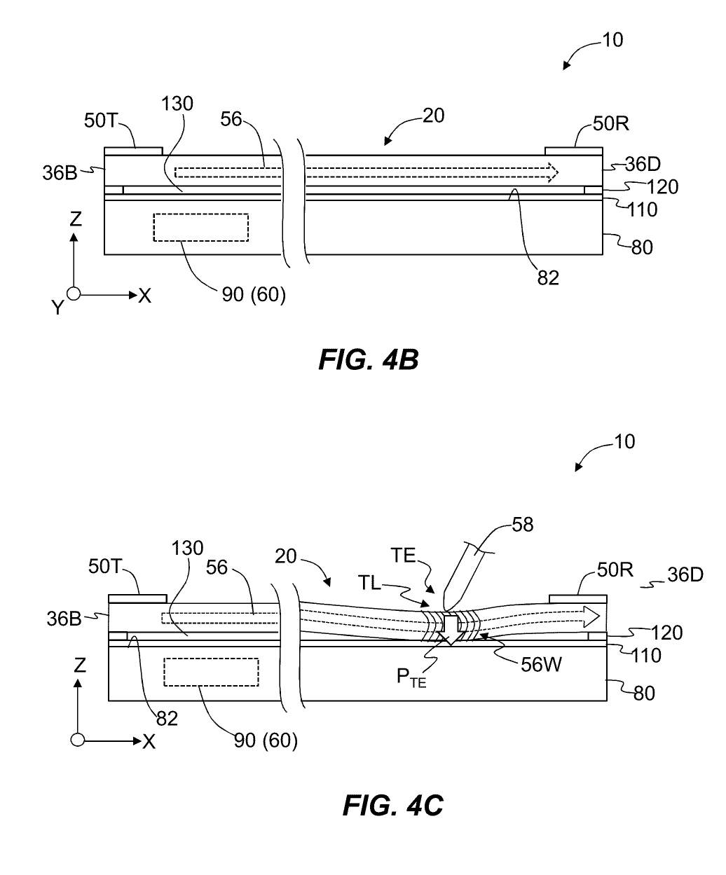

FIG. 4A is an elevated exploded view and FIG. 4B is a cross-sectional view taken in the X-Z plane of an example touch screen system 10, wherein assembly 20 is interfaced with a display panel 80 having a light-emitting side 82. An example display panel 80 is an LCD panel. In an example, light-emitting side 82 has conventional touch-sensing capability, such as capacitive touch-sensing or resistive touch-sensing. An example display panel 80 includes a controller 90 similar to controller 60 described above. In an example, controller 90 is configured to serve as controller 60 in the example touch screen 10 of FIG. 4A. In another example, controller 60 is maintained separate from controller 90 but the two controllers are operably linked.

A layer 110 of transparent acoustic-absorbing material (e.g., epoxy or film) is disposed atop light-emitting side 82 of display panel 80. Assembly 20 is disposed adjacent layer 110 and is spaced apart therefrom, such as by the use of a spacer 120, to define an air gap 130. Example materials for layer 110 include.

With reference to FIG. 3C, a touch event TE at touch location TL on glass sheet 30 caused by implement 58 (e.g., a stylus, as shown) applies pressure P_{TE} that causes the glass sheet to locally bend. The local bending of glass sheet 30 causes the bent portion to traverse air gap 130 and touch layer 110, thereby causing a portion of acoustic wave 56 traveling in the glass sheet to be absorbed by layer 110 as well as by implement 58. The amount of absorption depends on the applied pressure P_{TE} at the touch location TL and the particular material that makes up layer 110.

The example touch screen system 10 of FIGS. 4A through 4C enhances the pressure-sensing capability for dry and hard touch events TE, which are usually harder to detect than soft and wet touch events because the former involve less acoustic energy loss (i.e., less attenuation). Moreover, the touch-screen capability of the overall touch screen system 10 is enhanced when the touch-screen functionality of assembly 20 is combined with the touch-screen functionality of display panel 80.

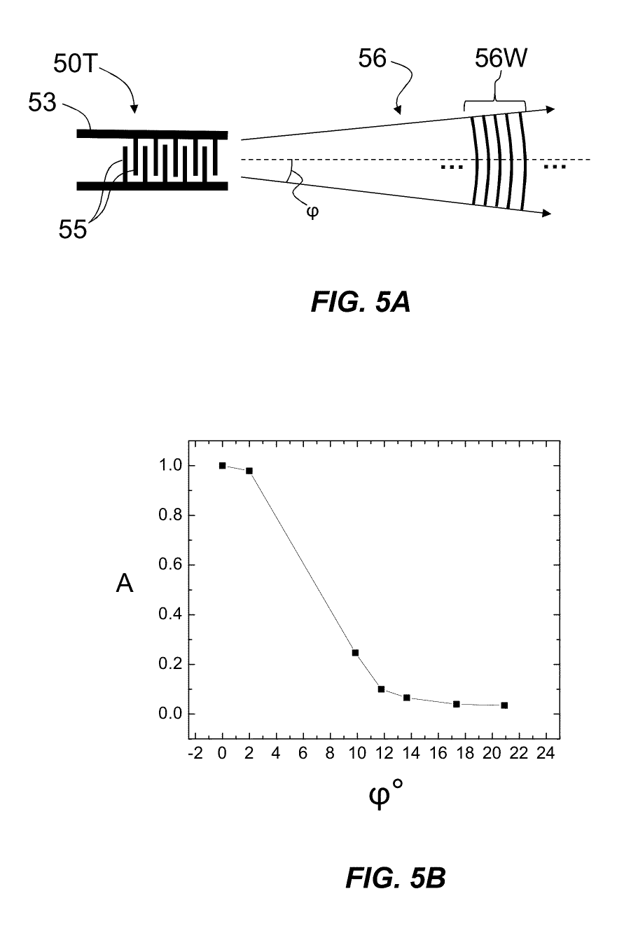

FIG. 5A is a schematic diagram of an example IDT piezoelectric thin-film acoustic transducer 50T showing an example of a diverging acoustic wave 56 emanating therefrom. Acoustic wave has a divergence angle φ, and FIG. 5B plots the normalized amplitude A of an example acoustic wave 56 versus the divergence angle φ in degrees. In the example shown, the divergence angle φ drops to about 0.5A at about φ=8° and drops off to about 0.1A at about φ=12°. In an example, transmitter 50T can have a greater divergence angle φ (e.g., 45° at 0.5A), e.g., by curving interleaved digits 55. Thus, in an example, divergence angle φ for transmitters 50T is such that an acoustic wave 56 from a single transmitter 50T is detected by its paired receiver 50R and at least one other receiver. Generally speaking, the greater the directionality of transmitters 501, the greater the accuracy in determining the touch location TL of the touch event.

### Baseline Measurement

In an example operation of touch system 10, controller 60 sequentially activates transmitters 50T to generate acoustic waves 56 of frequency f that travel through glass sheet 30 to one or more receivers 50R. As noted above, acoustic waves 56 can be transmitted in acoustic-wave pulses 56W having a pulse frequency γ. Receivers 50R detect acoustic waves 56 and in response generate receiver signals SR representative of the amount of acoustic energy received.

In the absence of a touch event TE, the resulting receiver signals SR represent a “no touch event” baseline that can be compared with other receiver signals SR taken later in time to determine if some of the receiver signals have been attenuated, and if the attenuation is sufficient (i.e., is greater than a threshold attenuation) to indicate the occurrence of a touch event TE. It is also noted that the strength (i.e., amplitude A) of acoustic waves 56 can vary between transmitters 50T and the detection efficiently of the acoustic waves can vary between receivers 50R.

Consequently, prior to operating touch system 10 to detect one or more touch events TE, touch system 10 is operated in a “no touch event” calibration mode so that the receiver signals SR can be normalized. Further, the baseline readings can be taken during system operation to account for any system drifts. Since normalized values for receiver signals SR are between 0 and 1, the receiver signal attenuation α_{R} can be defined as α_{R}=−ln(SR).

### Processing the Receiver Signals

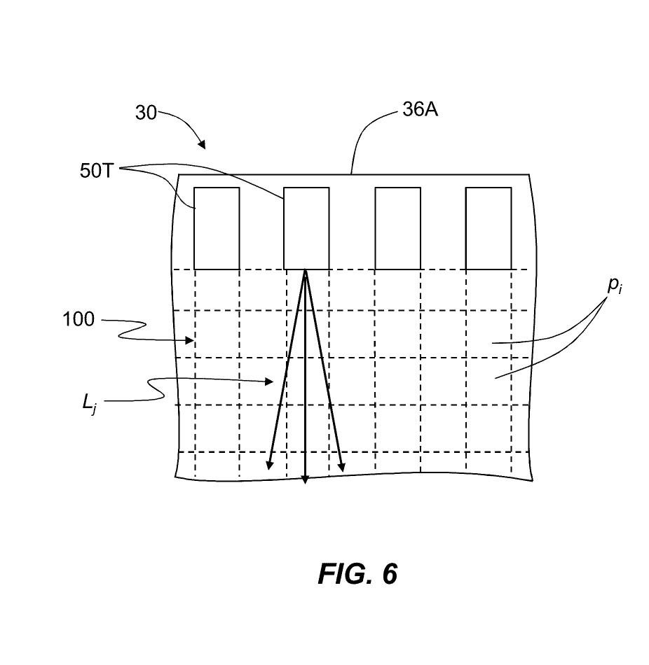

In a first example embodiment, a method called the “line method” is used to identify a touch location TE(x,y). In the line method, glass sheet 30 is divided into an imaginary pixel grid 100 of n pixels p, as shown in the close-up view of assembly 20 of FIG. 6. In an example, the number of pixels p in one row or column is at least twice the number of transmitters 50T adjacent each side 36A and 36B of glass sheet 30. The pixels pᵢ are numbered, e.g., p₁, p₂, . . . pₙ, with each pixel being assigned an unknown attenuation value Xᵢ for i=1 to n.

With reference to FIG. 1 and FIG. 6, lines L are drawn from each transmitter 50T to those opposing receivers 50R that can detect the acoustic signal 56. Lines L can be identified with a subscript ⱼ, i.e., Lⱼ, wherein j=1 to m, where m is the total number of lines L. For each line Lⱼ, the total attenuation bⱼ measured at the receiver 50R where the line Lⱼ terminates is given by:

$${\sum }_{i \_ along \_ line}^{ } {a}_{ji} {X}_{i} = {b}_{j}$$

where αⱼᵢ are coefficients proportional to length of line Lⱼ within pixel pᵢ. The pixels pᵢ along a line Lⱼ that has bⱼ=0 are assigned an attenuation Xᵢ=0.

This serves to define a set of linear equations corresponding to lines Lⱼ having non-zero attenuation. In the case of just a few touch events TE, the number of lines Lⱼ can be greater than number of remaining pixels to solve. If this is the case, a direct or an iterative solution can be employed. For example, a suitable iterative algorithm is called the algebraic reconstruction technique (ART) algorithm, and an even faster version is called the simultaneous algebraic reconstruction technique (SART).

Where just a few lines Lⱼ are involved (i.e., just a few receivers 50R detect a given acoustic wave 56 from a given transmitter 50T), a first example algorithm proceeds as follows:
1) Initialize all pixel attenuations Xᵢ to 0.
2) Start with a first line Lⱼ where bⱼ>TH, wherein TH is a minimal attenuation threshold above the noise level.
3) For each pixel pᵢ along line Lⱼ, add the value bⱼ·aⱼᵢ to obtain the total pixel attenuation.
4) repeat step 3) for the next line Lⱼ.
5) When all lines Lⱼ are processed, each pixel pᵢ has an accumulated attenuation.
6) Find all connected pixels pᵢ (called “blobs”).
7) Each blob has area equal to number of included pixels and a weight defined by the total accumulated attenuation.
8) Declare actual touch events TE for blobs having the highest weight or area.

The data obtained by processing the receiver signals SR using the above method can also be processed to obtain additional information about the touch event TE, such as a touch-event occurrence, a touch-event location, a touch-event duration, a touch-event pressure, and a time-evolution of the touch-event pressure.

In another example embodiment, a second method referred to herein as the “projection method” employs an algorithm based on the use of Radon transforms as known in the art (and used in tomography applications) is used to determine the occurrence of a touch event TE, as well as additional characteristics of the touch event. The method includes three main steps. The first main step involves collecting data from receivers 50T for one direction of acoustic waves 56, e.g., those traveling from transmitters' 50T adjacent side 36A to receivers 50R adjacent side 36C. This set of data is called a “projection.”

In applications where high accuracy is required, many projections are needed to construct an accurate attenuation map that shows the touch event TE. In our case, we can treat all parallel lines connecting transmitters 50T and receivers 50R as one projection. For example, if the acoustic wave 56 from each transmitter 50T is detected by three receivers 50R on the opposite side of glass substrate 30, there are a total of 3+3=6 projections.

Next, in the second main step, the parallel lines are sorted by spatial coordinate x. If a single projection with angle θ is denoted as f_{θ}(x), then a filter in the frequency domain is applied, wherein F_{θ}(ω) is the Fourier transform of f_{θ}(x) and R_{θ}(ω)=|ω|·F(ω) is the Radon transform of the projection in the frequency domain. Returning to spatial domain, r_{θ}(x) is inverse Fourier transform of R_{θ}(ω). Note that here the x axis is orthogonal to the projection. In other words, the touch event TE is projected onto the x axis.

Once r_{θ}(x) for several angles (projections) is determined, the third main step involves combining r_{θ}(x) into a reconstructed image of the touch event TE. For any given point (x,y) within the touch event TE, all radon transforms (r) of projections of that point are added (all projection lines passing through the point). Interpolation can be employed to obtain a finer grid. The result is an attenuation map.

Once the attenuation map is established, the touch events TE are determined using steps 6) through 8 from the first example algorithm.

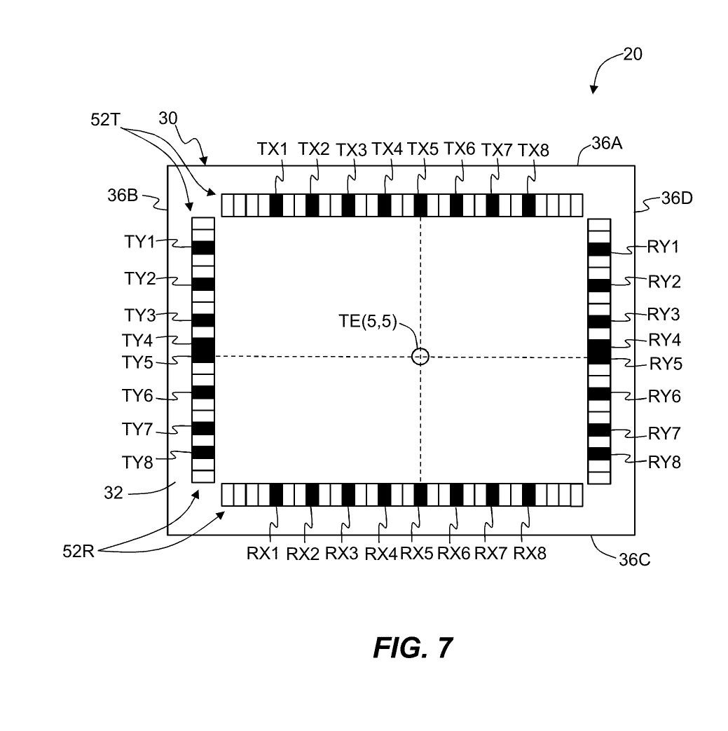

FIG. 7 is a top-down view of an example assembly 20 with a total of thirty transmitters 50T adjacent side 36A and a total of twenty-two transmitters adjacent side 36B. A subset of eight transmitters 50T adjacent side 36A is denoted TY1 through TY8 and a subset of eight transmitters adjacent side 36B is denoted as TX1 through TX8. Likewise, there are a total of twenty-two receivers 50R adjacent side 36D and eight of these are denoted RY1 through RY8 and of the thirty receivers 50R adjacent side 36C, eight are denoted RX1 through RX8. Transmitters TX and receivers RX are shown in black shading.

The configuration for assembly 20 of FIG. 7 was used as the basis for numerical simulations to determine the touch location TL(x,y) of a touch event TE.

Tables 1A and 1B below set forth exemplary data obtained by simulation for the amplitude of receiver signals SR for a given transmitter-receiver pair for the case where there is no touch event TE. That is, the data in Tables 1A and 1B are baseline data or a baseline “map.” Note that the maximum signal values are on the diagonal of the Tables 1A and 1B and illustrate that the direct-line transmission of acoustic wave 56 (e.g., TY1 to RY1, TY2 to RY2, etc.) between the transmitter-receiver pair has the strongest amplitude.

Note that TX and TY are reversed here as compared to the data provided in the PPT information provided because the coordinates are reversed.

TABLE 1A

| | RY1 | RY2 | RY3 | RY4 | RY5 | RY6 | RY7 | RY8 |
|---|---|---|---|---|---|---|---|---|
| TY1 | 1.31 | 0.728 | 0.232 | 0.058 | 0.044 | 0.059 | 0.051 | 0.037 |
| TY2 | 0.88 | 1.32 | 0.948 | 0.228 | 0.128 | 0.046 | 0.056 | 0.064 |
| TY3 | 0.184 | 0.752 | 1.18 | 0.748 | 0.584 | 0.069 | 0.028 | 0.05 |
| TY4 | 0.03 | 0.156 | 0.508 | 0.76 | 0.776 | 0.32 | 0.102 | 0.038 |
| TY5 | 0.0328 | 0.118 | 0.784 | 1.26 | 1.1 | 0.692 | 0.28 | 0.052 |
| TY6 | 0.064 | 0.058 | 0.21 | 0.904 | 0.836 | 1.39 | 0.896 | 0.236 |
| TY7 | 0.024 | 0.055 | 0.063 | 0.165 | 0.215 | 0.87 | 1.34 | 0.884 |
| TY8 | 0 | 0.033 | 0.073 | 0.029 | 0.041 | 0.282 | 1.04 | 1.38 |

TABLE 1B

| | RX1 | RX2 | RX3 | RX4 | RX5 | RX6 | RX7 | RX8 |
|---|---|---|---|---|---|---|---|---|
| TX1 | 1.98 | 0.968 | 0.056 | 0.088 | 0.054 | 0.027 | 0.026 | 0 |
| TX2 | 0.663 | 2.03 | 0.868 | 0.054 | 0.11 | 0.056 | 0.032 | 0 |
| TX3 | 0.06 | 0.8 | 2.71 | 1.07 | 0.092 | 0.11 | 0.049 | 0.025 |
| TX4 | 0.091 | 0.088 | 1.58 | 2.16 | 1.02 | 0.056 | 0.096 | 0.088 |
| TX5 | 0.027 | 0.046 | 0.07 | 0.864 | 1.82 | 0.692 | 0.072 | 0.07 |
| TX6 | 0.026 | 0.03 | 0.085 | 0.105 | 1.06 | 1.97 | 1.14 | 0.128 |
| TX7 | 0.084 | 0 | 0.068 | 0.076 | 0.104 | 1.02 | 2 | 0.872 |
| TX8 | 0.064 | 0 | 0 | 0.046 | 0.101 | 0.057 | 0.848 | 1.76 |

FIG. 7 also shows a touch event TE at TL (5,5). Tables 2A and 2B set forth simulation data similar to Tables 2A and 2B, but for the touch event TE at touch location TL(5,5) having an associated pressure P_{TE} as defined by the application of a force of 0.014 lb applied to glass sheet 30 with a rubber stylus having an area of 10 mm×10 mm (i.e., 100 mm²). This defines a localized pressure P_{TE}≈6.2×10⁻⁴ N/mm². The numbers in Tables 2A and 2B that are preceded by an asterisk * indicate changed values from Tables 1A and 2A, respectively, i.e., a change in the measured strength of receiver signal SR, which represents a measure of the attenuation of the corresponding acoustic wave 56.

TABLE 2A

| | RY1 | RY2 | RY3 | RY4 | RY5 | RY6 | RY7 | RY8 |
|---|---|---|---|---|---|---|---|---|
| TY1 | 1.31 | 0.728 | 0.232 | 0.058 | 0.044 | 0.059 | 0.051 | 0.037 |
| TY2 | 0.88 | 1.32 | 0.948 | 0.228 | 0.128 | 0.046 | 0.056 | 0.064 |
| TY3 | 0.184 | 0.752 | 1.18 | 0.748 | 0.584 | 0.069 | 0.028 | 0.05 |
| TY4 | 0.03 | 0.156 | 0.508 | *0.648 | *0.244 | 0.32 | 0.102 | 0.038 |
| TY5 | 0.0328 | 0.118 | 0.784 | *0.514 | *0.478 | *0.592 | *0.232 | 0.052 |
| TY6 | 0.064 | 0.058 | *0.098 | *0.676 | *0.996 | 1.39 | 0.896 | 0.236 |
| TY7 | 0.024 | 0.055 | 0.063 | 0.165 | 0.215 | 0.87 | 1.34 | 0.884 |
| TY8 | 0 | 0.033 | 0.073 | 0.029 | 0.041 | 0.282 | 1.04 | 1.38 |

TABLE 2B

| | RX1 | RX2 | RX3 | RX4 | RX5 | RX6 | RX7 | RX8 |
|---|---|---|---|---|---|---|---|---|
| TX1 | 1.98 | 0.968 | 0.056 | 0.088 | 0.054 | 0.027 | 0.026 | 0 |
| TX2 | 0.663 | 2.03 | 0.868 | 0.054 | 0.11 | 0.056 | 0.032 | 0 |
| TX3 | 0.06 | 0.8 | 2.71 | 1.07 | *0.05 | *0.061 | 0.049 | 0.025 |
| TX4 | 0.091 | 0.088 | 1.58 | 2.16 | 1.02 | 0.056 | 0.096 | 0.088 |
| TX5 | 0.027 | 0.046 | 0.07 | *0.928 | *0.576 | *0.728 | 0.072 | 0.0 7 |
| TX6 | 0.026 | 0.03 | 0.085 | 0.105 | 1.06 | 1.97 | 1.14 | 0.128 |
| TX7 | 0.084 | 0 | 0.068 | 0.076 | 0.104 | 1.02 | 2 | 0.872 |
| TX8 | 0.064 | 0 | 0 | 0.046 | 0.101 | 0.057 | 0.848 | 1.76 |

FIG. 8A plots the normalized signal values associated with transmitters TY and receivers RY from Table 1A for the no-touch baseline, while FIG. 8B plots the normalized signal values associate with transmitters TY and receivers RY values from Table 2A for the touch event TE at touch location TL(5,5). FIG. 8C plots the TY and RY values of Table 2A with the baseline values of Table 1A subtracted out and then the absolute value of the data taken. The data of plots FIGS. 8B and 8C show the touch location TL as being centered on the (5,5) coordinate. Similarly, FIG. 8D plots TX and RX values of Table 2B to show the touch locations TL as being centered on the (4,5) coordinate and the (6,5) coordinate.

FIG. 8E is similar to FIG. 8C and shows the normalized response data with the baseline subtraction for two touch events: one at touch location TL (2,2) and one at touch location TL(5,5). The simulation data of FIG. 8E accurately reveals these two touch locations.

The amount of pressure P_{TE} associated with a given touch event TE can be deduced by performing a calibration wherein different amounts of pressure are applied to different locations on glass sheet 30. A look-up table of signal attenuation versus pressure P_{TE} versus touch location TL(x,y) can be constructed. Interpolation can be used to provide data for a large number of touch locations in between actual measured touch locations. Once a touch event TE is detected and its location TL(x,y) identified, then the signal data can be analyzed to ascertain the amount of pressure P_{TE} for the touch location.

The time-evolution of the pressure P_{TE}(t) can be determined by examining the signal data for different times and noting the change in the signal values. The aforementioned look-up table can be used to establish the pressure P_{TE}(t) for a given time associated with the duration of the touch event. The various values of P_{TE} for different times are then used to define P_{TE}(t). In an example illustrated in FIG. 9, a best-fit curve 200 is applied to the P_{TE} data for different times t to obtain a more detailed characterization of P_{TE}(t).

Although the embodiments herein have been described with reference to particular aspects and features, it is to be understood that these embodiments are merely illustrative of desired principles and applications. It is therefore to be understood that numerous modifications may be made to the illustrative embodiments and that other arrangements may be devised without departing from the spirit and scope of the appended claims.

What is claimed is:

1. A touch system for sensing at least one touch event, comprising:
a glass sheet having a body with a perimeter and generally parallel top and bottom surfaces that define a substantially constant thickness d in the range from 0.1 mm≦d≦1 mm;
a plurality of piezoelectric thin-film acoustic transducers formed adjacent the perimeter of the glass sheet on either the top or bottom surface, wherein a first set of the acoustic transducers serve as acoustic-wave transmitters and a second set of the acoustic transducers serve as acoustic-wave receivers that generate receiver signals in response to receiving acoustic waves, wherein the acoustic waves have a frequency f in the range from 0.5 MHz≦f≦5 MHz; and
controller means for controlling the activation of the acoustic-wave transmitters and processing the receiver signals to determine at least once characteristic of the at least one touch event.

2. The touch system according to claim 1, wherein the at least one characteristic of the at least one touch event is selected from the group of characteristics comprising: a touch-event occurrence, a touch-event location, a touch-event duration, a touch-event pressure, and a time-evolution of the touch-event pressure.

3. The touch system according to claim 1, wherein the glass sheet is made of a chemically strengthened glass.

4. The touch system according to claim 1, wherein the acoustic waves comprise pulses having a pulse frequency γ in the range 1 Hz≦γ≦100 Hz.

5. The touch system according to claim 1, wherein the glass sheet and acoustic transducers are operably disposed relative to a display panel that has touch-sensing capability.

6. The touch system according to claim 5, wherein the display panel includes a transparent acoustic-absorbing film, and wherein the glass sheet locally contacts the acoustic-absorbing film at a location corresponding to the at least one touch event.

7. An acoustic-sensing assembly for a touch system for sensing at least one touch event, comprising:
a glass sheet having a body with a perimeter and generally parallel top and bottom surfaces that define a substantially constant thickness d in the range from 0.1 mm≦d≦1 mm;
a plurality of interdigital piezoelectric thin-film acoustic transducers formed adjacent the perimeter of the glass sheet on either the top or bottom surface, wherein a first set of the acoustic transducers serve as acoustic-wave transmitters and a second set of the acoustic transducers serve as acoustic-wave receivers, with each acoustic transducer being adapted to generate acoustic waves having a frequency f in the range from 0.5 MHz≦f≦5 MHz when provided with a transmit signal.

8. The acoustic-sensing assembly according to claim 7, wherein the glass sheet is made of a chemically strengthened glass.

9. The acoustic-sensing assembly according to claim 8, wherein the chemically strengthened glass consists of Gorilla® glass.

10. The acoustic-sensing assembly according to claim 7, wherein the glass sheet has a generally rectangular shape.

11. The acoustic-sensing assembly according to claim 7, wherein the acoustic-wave transmitters and receivers are configured so that the acoustic wave transmitted by a given acoustic-wave transmitter is received by between one and 50 acoustic-wave receivers.

12. A method of sensing at least one touch event, comprising:
sending acoustic waves through a glass sheet having generally parallel top and bottom surfaces that define a substantially constant thickness d in the range 0.1 mm≦d≦1 mm, wherein the acoustic waves have a frequency f in the range 0.5 MHz≦f≦5 MHz, wherein the acoustic waves are generated by a first set of piezoelectric thin-film acoustic transducers formed on either the top or bottom of the glass sheet;
receiving the acoustic waves with a second set of the acoustic transducers and generating in response receiver signals; and
processing the receiver signals to determine at least once characteristic of the at least one touch event.

13. The method of claim 12, wherein the at least one characteristic of the at least one touch event is selected from the group of characteristics comprising: a touch-event occurrence, a touch-event location, a touch-event duration, a touch-event pressure, and a time-evolution of the touch-event pressure.

14. The method of claim 12, wherein processing the receiver signals includes performing a baseline measurement when there is no touch event.

15. The method of claim 14, wherein processing the receiver signals includes performing either a line algorithm or a projection algorithm.
